(19) United States
(12) Patent Application Publication
(10) Pub. No.: US 2025/0256234 A1
(43) Pub. Date: Aug. 14, 2025

(54) GROUNDED DETERGENT AIR FILTER

(71) Applicant: David Matthew Mooney, Vanier (CA)

(72) Inventor: David Matthew Mooney, Vanier (CA)

(21) Appl. No.: 19/049,626

(22) Filed: Feb. 10, 2025

Related U.S. Application Data
(60) Provisional application No. 63/551,491, filed on Feb. 8, 2024.

(51) Int. Cl. B01D 46/66; B01D 46/00; C11D 1/12; C11D 1/66; C11D 3/20

(52) U.S. Cl. CPC B01D 46/66; B01D 46/0035; C11D 1/12; C11D 1/66; C11D 3/2065; C11D 2111/16

(57) ABSTRACT

An electrostatics-enhanced air filter that produces an electrostatic attraction for dust particles using an electrical ground or electrically charged filter is disclosed. The present invention takes advantage of the mirror-charge effect that spontaneously induces an opposite and attractive charge on the filter that pulls in dust particles. A fibrous filter medium pad is impregnated with a liquidus solution, which is a conductive aqueous electrolyte solution which would capture dust particles. Charges on dust particles would be drained off through the liquidus solution to the ground, preventing the effective electrical potential of the filter from changing. The liquidus solution also contains a detergent that keeps the filter clear of oily air contaminants to maintain conductivity through the filter service life. The liquidus solution contains a wetting agent for engulfing dust particles therein/thereon. The liquidus solution also contains a hygroscopic agent that prevents it from partially drying during its use.

### CROSS-REFERENCE TO RELATED APPLICATIONS

The present application claims priority to U.S. provisional application No. 63/551,491, filed on Feb. 8, 2024, the content of which is incorporated by reference in its entirety.

### FIELD OF INVENTION

The present invention relates to air filters, in particular, residential air filters, furnace filters, home air cleaning appliances, and the like.

### BACKGROUND

Air filters have various applications, including but not limited to residential, office, and industrial air conditioning/cleaning, manufacturing dust management, etc.; however, as stated in the blog post on Camfil Canada Inc.'s website published on Jul. 4, 2022, almost all air filters commercially available have various issues, one of which may be: “Degradation of particle efficiency has been known and acknowledged by ASHRAE since the inception of the 52.2 standard in 1999. In fact, ASHRAE stated very clearly that some air filters have electrostatic charges that are either naturally imposed or imposed during the manufacturing process. This type of air filter will demonstrate a very high level of particulate efficiency when clean but will drop in particulate efficiency during its actual use cycle.” (The emphasis is in the original.) (ILIJEVSKI, Phillip et al, “MERV AIR FILTER TESTING IN CANADA”, Camfil, Jul. 4, 2022, https://cleanair.camfil.ca/merv-air-filter-testing/, accessed on Jan. 30, 2025). (Please note that the abbreviation “ASHRAE” stands for American Society of Heating, Refrigeration, and Air-conditioning Engineers.) Various attempts have been made to improve or address the issues shown above. For example, filers using electrostatic attraction to perform filtering at or about MERV-12 level (MERV, minimum efficiency reporting value) have been proposed; however, these are unable to address all or some of the issues.

Various other attempts have been made by use of microscopically spaced, fine fibers; however, such tight gaps would have greater airflow resistance per unit area and thus may not be desirable for various applications, as this strategy will require greater surface area to offset the greater air resistance to obtain sufficient air flow for certain application(s). Accordingly, a long-felt need has existed for an air filter that delays the degradation of particle efficiency or decreases the rate of said degradation over a period of time, without significantly increasing the airflow resistance of an air filter.

### BRIEF SUMMARY OF THE INVENTION

According to an object of the present invention, it provides a filter of which the efficiency is more likely to remain constant over the 3 months of its use while performing at about MERV 12 level (MERV, minimum efficiency reporting value). The in-use lifetime of static charges artificially applied to the filter medium according to the present invention would not be a limitation.

According to another object of the present invention, it provides a filter that offers a price advantage over air filter products that rely not on electrostatics but rather on a very close, microscopic spacing of very fine fibers to achieve consistent high-MERV performance. As stated above, the relatively tight “weave” of such a media pad will cause a relatively great airflow resistance per unit area and necessitate a great expansion in surface area to offset it so that the product remains drop-in compatible with competing filters. Furthermore, the greater surface area would usually result in a cost increase and thus not be desirable. According to yet another object of the present invention, it provides a filter that stops moderate amounts of oil mist.

Viscous impingement (VI) air cleaning technology uses a filter medium wetted with a liquid to remove particulate matter from air, as does the present invention, but the present invention shows the following relative advantages: 1) high face velocities are not required; these represent a power cost at the blower, and in fact the present invention can operate with zero face velocity; 2) the aqueous solutions of the present invention are easier to clean than VI oil and are nonflammable; 3) contaminant particles do not have to be relatively large and massive with the present invention; and 4) VI airways are too wide to optimally intensify Coulombic forces acting on dust particles, such intensification being an important consideration with the present invention.

Moreover, the MERV industry standard filter efficiency test (ASHRAE 52.2) requires neutralization of the efficiency-measuring aerosol (which is not the loading dust) to remove most electrostatic charges therefrom before it enters the testing duct. (The standard goes on to state that “This [minimum charge] represents the charge distribution of the ambient aerosol” but without citing any experimental support for this.) This standard provision of neutralization teaches away from the present invention; theoretically, the present invention is less efficient if all ambient particulate matter is minimally charged, but is rather based on exploiting the ubiquitousness of electric charges on ambient particulate matter, which includes aerosols. (In consequence, no MERV ratings of the present invention are provided here.)

According to the preferred embodiment of the present invention, it provides an air filter, comprising a media pad being impregnated with a liquidus solution; a metal grid attached to the media pad, covering substantially an entire area of the media pad; an electrical connection that electrically maintains the metal grid at ground potential or non-ground voltage source. The liquidus solution comprising, a detergent; a hygroscopic agent; and an electrolyte. The detergent is an alkyl sodium sulfonate or non-ionic detergent. The hygroscopic agent is glycerin. The electrolyte comprises an ionizable substance selected from the group consisting of an ionic detergent, sodium sulfate, and sodium bicarbonate. The non-ground voltage source is a battery or a charge pump.

According to yet another embodiment of the present invention, it provides an air filter, comprising: a pair of conductive mesh filters, a first one of which is adapted to be electrically positively charged; and a second one of which is adapted to be electrically negatively charged; a liquidus solution covering the positively and negatively charged conductive meshes. The pair of conductive mesh filters are metallic mesh filters, conductive plastic mesh filters, or a combination thereof. Air passes between the pair of conductive mesh filters, passes sequentially among the pair of conductive mesh filters; or passes about one of the pair of conductive mesh filters. The liquidus solution comprising: a detergent; a hygroscopic agent; and an electrolyte. The detergent is an alkyl sodium sulfonate or non-ionic detergent. The hygroscopic agent is glycerin. The electrolyte comprises an ionizable substance selected from the group consisting of an ionic detergent, sodium sulfate, and sodium bicarbonate. The pair of conductive mesh filters are electrically charged by a battery. The pair of conductive mesh filters are arranged horizontally in parallel or side-by-side, or vertically in parallel or side-by-side.

According to further embodiment of the present invention, it provides an air cleaning device comprising: a duct for receiving air from a first opening and flowing through to a second opening; an air ionizer disposed within the duct, the air from the first opening passes through the air ionizer for ionizing the air; the air filter as defined above disposed within the duct for filtering the air ionized by the air ionizer. The air ionizer comprises an array of conductive points with a high voltage for ionizing the air, wherein a high voltage is higher than 10 kilovolts. The air ionizer is an unbalanced air ionizer.

### BRIEF DESCRIPTION OF THE SEVERAL VIEWS OF THE DRAWINGS

FIG. 1 is a cross-sectional side view of an air filter in accordance with a preferred embodiment of the present invention;

FIG. 2 is a face-on view of the air filter;

FIG. 3 is a cross-sectional side view of an enlarged portion of the air filter;

FIG. 4a is a block diagram of an air filter in accordance with another preferred embodiment of the present invention;

FIG. 4b is another block diagram of an air filter in accordance with yet another preferred embodiment of the present invention;

FIGS. 5, 6 and 7 show graphs showing the performance of a non-preferred embodiment of the present invention in comparison with otherwise identical embodiments with one or more claims omitted. (Although at best non-preferred, these embodiments were physically simple and therefore offered advantages in carrying out experiments.) FIG. 8 is a cross-sectional side view of an air filter in accordance with another preferred embodiment of the present invention.

### DETAILED DESCRIPTION OF INVENTION/DRAWINGS

This invention combines chemistry, electricity, and mechanics to meet the innate complexity of airborne contaminants with a complex and subtle filtration solution. This invention aims at providing MERV-12 performance or better at MERV-7 prices.

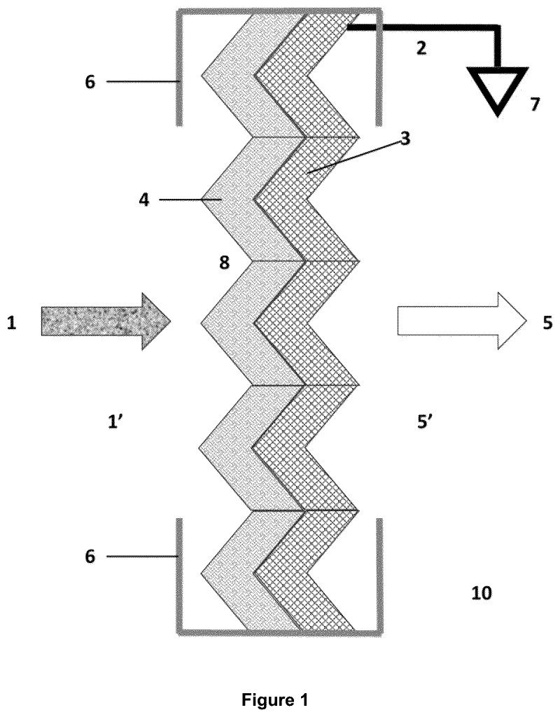

FIG. 1 shows a cross-sectional view of an air filter 10 according to a preferred embodiment of the present invention. The air filter 10 comprises a frame 6 enclosing a fibrous filter media pad 4 and metal grid 3 covering substantially an entire area or a surface of the media pad 4, where air flows toward the air filter 10 on the upstream side 1′ in the direction 1, through the filter 10, and exits on the downstream side 5′ in the direction of outgoing airflow 5. As shown in FIG. 1, the filter media pad 4 is disposed on the upstream side, while the metal grid 3 is disposed on the downstream side of the airflow. The metal grid 3 is electrically grounded by an electrical connection through a grounding wire 2 to a building safety ground 7. The metal grid 3 is bonded to and conforms to the fibrous filter media pad 4. The metal grid 3 optionally supports the media pad 4 against any air pressure differentials between the upstream side 1′ and downstream side 5′. Yet further optionally, the metal grid 3 is embedded inside or layered with the media pad 4.

The metal grid 3 and the fibrous filter media pad 4 are bonded hermetically to the frame 6. This arrangement allows the filter 10 to be inserted into a slot prepared in a furnace so that the filter 10 may operate without a problematic, unusually large bypass of contaminated air.

The filter media pad 4 is that of a typical MERV 7 or 8 furnace filter and is impregnated at manufacture with a liquidus solution 8 according to the present invention.

According to one embodiment of the present invention, the liquidus solution 8 comprises:
a detergent (e.g., an alkyl sodium sulfonate or a non-ionic detergent);
a hygroscopic agent (e.g., glycerin); and
an electrolyte (e.g., an ionic detergent, sodium sulfate, sodium bicarbonate, or ionizable substances contributed by the captured air contaminants themselves).

All liquid components are preferably free of ions that promote the corrosion of steel, such as chloride. Moreover, water-hardness cations such as calcium, iron, and magnesium are preferably avoided.

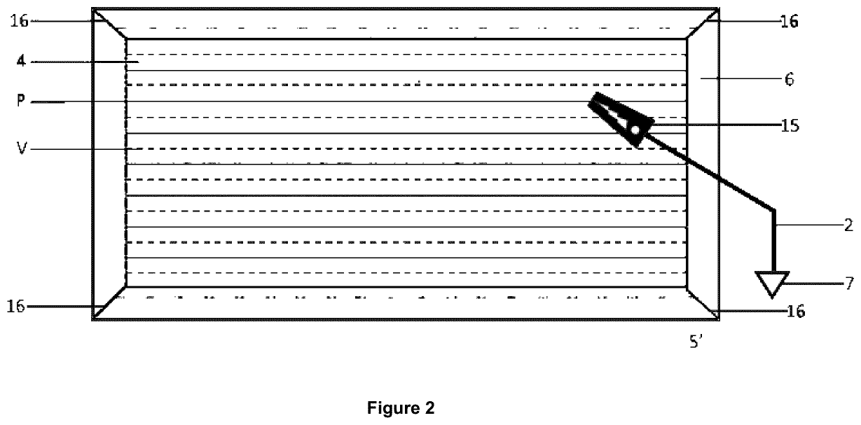

FIG. 2 shows a bottom view of the filter 10 (downstream side 5′). The fibrous filter medium (“media pad”) 4 is bonded to the metal backup grid 3 (not shown) and the media pad 4 and the metal grid 3 are pleated into a plurality of peaks P and valleys V. The frame 6 may have a plurality of joints 16, for example, each of the four corners of the filter 10. All of the joints 16 of the frame 6 on the downstream side 5′ are air-tightly sealed. For sealing the joints 16, a suitable sealant, such as a sealant for airline fitting, may be used. The joints 16 may be constructed to structurally improve and keep the airtightness.

According to the preferred embodiment of the present invention, the filter 10 is electrically grounded. In the further preferred embodiment of the present invention, fibrous filter media pad 4 and metal grid 3 are grounded, preferably to the building safety ground. For example, a fastener 15, such as an alligator clip, may be affixed to one of the peaks P (or valleys V) and grounded to the building safety ground 7 through the grounding wire 2.

According to the preferred embodiment of the present invention, the media pad 4 may be made of synthetic, fiberglass or suitable electrostatic material. It is preferably not made of pleated paper or cardboard materials, since paper or cardboard material lose their strength after prolonged contact with the liquidus solution/water.

It is to be understood that the point of electrical connection of the ground potential source (i.e., building safety ground 7) to the backup metal grid 3 would become vulnerable to electrolytic corrosion in the presence of various liquidus solutions. This corrosion could lead to loss of the ground connection. Accordingly, the connector 15 and grounding wire 2 are preferably made of similar metals as the backup metal grid 3. The connector 15 may be replaced by directly soldering or welding the grounding wire to the metal grid 3 and/or media pad 4, where, in that case, the soldered/welded portion or the connector 15 may be protected from corrosion by use of antioxidant paste with/without a waterproof coating.

Moreover, during the normal course of operation or use of the filter 10, the liquid may easily be spread beyond the filter 10 to produce unintended ground connections/short circuits. This could happen, especially, in wet/high-humidity conditions. This type of condition can accelerate electrolytic corrosion of the metal grid 3 or prevent the metal grid 3 from being operated at non-ground potentials, if the use of non-ground potentials should prove advantageous.

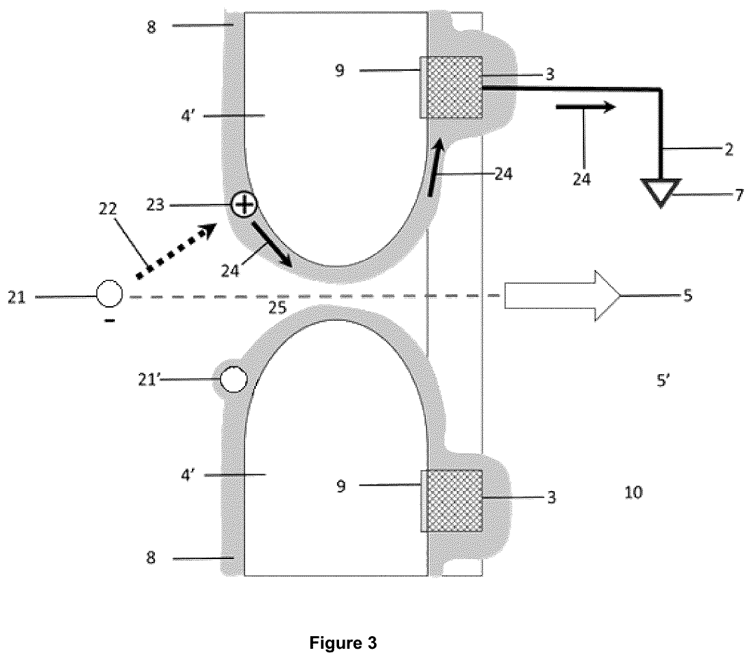

FIG. 3 shows a cross-section view of an enlarged portion of the filter 10, having a sheet of fibers 4′ of the fibrous filter media pad 4 and metal backup grid 3. A negatively charged dust particle 21 entrained in the airflow (the dashed line indicates entrainment) experiences a Coulombic force of attraction 22 toward the filter as the result of inducing thereon a positive mirror charge 23, a process requiring a flow of negative charge 24 to the metal backup grid 3 and thence to building safety ground 7 through grounding wire 2, resulting in particles being captured in and along the fibrous filter media pad 4 and thus a cleaner air flow to downstream side 5′. A captured particle 21′ may be engulfed by the liquidus solution 8 and therefore electrically neutralized over its entire surface. The metal backup grid 3 is adhered to the sheet of fibers 4′ of the media pad 4 with an adhesive 9. Each sheet of fibers 4′ is coated with, and serving as a reservoir for, the liquidus solution 8, which is an electrically conductive liquid that allows the presence of pores 25 through the filter 10. The pores 25 represent that part of the porosity of the media pad 4 that survives impregnation with the liquid 8.

Substantially all of the air would need to pass through the pores 25 of the filter 10 to clean the air, thus air would pass through very closely to the surfaces of the sheets of fibers 4′ which are impregnated with and covered with the liquidus solution 8. The action/process of air passing closely with the surfaces of sheets of fibers 4′ maximizes the strength of the Coulombic forces acting to capture the dust particles in the air flow, because such forces increase with the inverse square of the separation. This advantageously allows weakly charged particles to be captured as well as strongly charged particles. The Coulombic force is somewhat spatially distributed, thereby reducing the need for tight control of pore size during manufacture. The larger dust particles appear to be removed by ordinary mechanical capture on the filter media pad.

According to a preferred embodiment of the present invention, the liquidus solution 8 is a glycerin-detergent mixture, which is impregnating the filter media pad 4 of the filter 10 and having the supporting metal backup grid 3, which is grounded.

TABLE 1
Detergent for liquidus solution

| | |
|---|---|
| 1. sodium lauryl sulfate | anionic detergent |
| 2. sodium laureth sulfate | anionic detergent |
| 3. c10-16 alkyldimethylamine oxide | non-ionic detergent |
| 4. c9-11 pareth-8 | non-ionic detergent and dirt suspending agent |
| 5. sodium cumene sulfonate | anionic surfactant and hydrotrope for ingredient 4. |

The preferred detergent is a mixture of all ingredients given in Table 1, which is based on information published by the manufacturer of a commercial cleaning product (Dawn Ultra™; Procter & Gamble®, Inc., Toronto, Ontario, Canada), and is listed in order of concentration. The exact proportions of all active ingredients making up the detergent component of the mixture are not available. When impregnated, the fibrous part of the filter advantageously retains an almost dry appearance, leading to robust and convenient operation independent of gravity. (This is an advantage over scrubber-like structures containing pumps and spray nozzles.)

As stated above, according to the preferred embodiment of the present invention, the filter 10 preferably has an electrically conductive component (such as metal grid 3) that touches the filter media pad 4 at a regular array of points over the entire surface of the media pad 4. Closer spacing of the points in both long dimensions is preferred over wider spacing. The conductive component is herein called the metal backup grid or backup grid as stated above. If pleating is present in the filter media pad 4, the filter media pad 4 is to be imagined as having been flattened out, without altering the points of contact by the metal grid 3.

The liquidus solution 8 according to the present invention may be prepared with added distilled water to facilitate processing steps such as mixing and spraying.

An optimal ratio for the liquid mixture was glycerin:detergent 7:3 v:v as-received basis, or 15:1 w:w, anhydrous basis. As received, the commercially available detergent contained 80% water by volume and the glycerin was anhydrous. Glycerin has a density of 1.26 g/cc and the anhydrous detergent is assumed to have a density of 1 g/cc, that of the common detergent sodium dodecyl sulfate.

Through the inventor's experiments, the aforementioned optimal ratio maximizes the detergent content of mixtures that show almost no signs of drying when equilibrated under worst-case winter indoor conditions for 10 days (relative humidity=26%, 10-day average). It is verified through the experimentation that the winter-equilibrated mixture is electrically conductive and remains liquidous and homogeneous for days at below-freezing temperatures. The winter-equilibrated mixture showed no signs of microbial growth. The detergent used was a mixture of anionic and non-ionic detergents (called herein “commercial dish detergent” in Table 1).

According to a preferred embodiment of the present invention, preferred loading ranges of the liquidus solution 8 would be anhydrous glycerin 23-53 g/m² and anhydrous commercial dish detergent 1.6-3.6 g/m². Basis is square meters of media pad. On a basis of total anhydrous liquid ingredients to media pad weight, the preferred loading range is 0.53 to 1.2 w/w.

The liquid loading on the filter should be less than that which quadruples the pressure drop across the media pad at a standard air flow rate after equilibration under conditions of 80% relative humidity and 19° C. (i.e., outdoor 2023 summer conditions, humid-continental climate type, 45°N). Alternative phrasing: the liquid layer on the filter shall not be thick enough to narrow the pores of the filter to the point of quadrupling the pressure drop under worst-case conditions of monthly averaged relative humidity. Humidity affects the uptake of atmospheric water vapor by the hygroscopic agent, thus possibly affecting the volume of the applied liquid component post-application, during use.

It is expected that the optimal mixture will have some weight and volume gain during use of the present invention, comparing it with the conventional commercial air filters. The weight and volume gains would be expected from the large content of glycerin, a hygroscopic agent, and which might unacceptably increase the flow resistance of the filter 10.

During the experiment, it was observed that, after a 20-day equilibration in controlled-humidity air at 21° C., the weight gain of a 50-g sample of the optimal-ratio mixture (made with only as-received detergent and anhydrous glycerin) as a function of percent relative humidity (RH) was: % weight gain/starting weight=0.0085×RH²−0.2056×RH−8.88. The RHs tested were 28, 53, and 81%. The maximum observed weight gain was 30% of the starting weight, at 81% RH. The great majority of the change happened within the first 10 days of equilibration. Accordingly, the weight and volume gains would not be of concern for its operation and use thereof.

TABLE 2
Static pressure test results

| | Static airflow resistance, |
|---|---|
| Sample | inches of water column |
| Low-end commercial pre-filter, 1″ thick | 0.55 |
| Prototype, liquid loaded at 1.2 anhyd. w/w on | 0.50 |
| media | |
| Prototype, liquid loaded at 0.53 anhyd. w/w on | 0.45 |
| media | |
| Prototype basis filter, no liquid loading | 0.44 |
| High-end commercial pre-filter, 2″ thick | 0.40 |

Abbreviations: anhyd., anhydrous basis

Referring to Table 2, above, showing static pressure test results, the prototypes were equilibrated at 42% RH; all tests were done at 1400 cfm (per ASHRAE 52.2 industry standard); all filters were 20×20×1″ unless otherwise indicated; outdoor air was used (68% RH, 10° C.).

The experimental results in Table 2 show that loading the basis filter at the maximum liquid loading covered by the preferred loading range did not unacceptably increase the resistance of the filter to airflow through it after equilibration at 42% RH.

The glycerin-based liquid may be applied to the media pad 4 of the filter 10 with brushing or, preferably, spraying. When spraying, even small dry spots must be avoided, because these are effectively holes in the filter. For consistency, during the manufacturing process, any dry spots would need to be minimized or avoided.

The liquidus solution 8 may soften and/or weaken any cardboard based frame 6. Thus, the frame 6 may be coated such that the frame 6 would be impermeable, preventing softening and/or weakening of the frame 6.

The grounding wire 2 would be affixed, soldered or welded to a point on the metal backup grid 3, allowing to create a reliable ground connection.

The electrical resistance between a point on the impregnated filter at the geometric center of a typical opening in the metal backup grid 3 and the nearest point of ground potential (with the building safety ground 7) is preferably not greater than one megohm. The resistance is measured and determined with an alternating-current ohmmeter or with a soil moisture sensor due to rapid electrode polarization if direct current is used with probes not plated with an electrocatalytic conductor.

The ground connection can optionally be replaced by a connection to an energy-requiring charge pump that is controlled by a servomechanism that maintains a constant voltage on the filter media pad 4/metal grid 3. This arrangement may be needed if no ground connection is available (e.g., on an aircraft).

The intended use lifetime of this filter for residential air conditioning units is about three months, indoors, any season. For example, a new filter according to the present invention may be inserted into the filter slot of a domestic furnace and its metal backup grid reliably and reversibly connected to ground potential, e.g., to a nearby flange of galvanized metal on the ducting.

According to another preferred embodiment of the present invention, a media pad may contain a mixture of large and small pores, where the large pores serve to facilitate the passage of air through the filter and the small pores serve to imbibe the liquidus solution 8 component by capillary action so as to provide a reservoir for the liquidus solution 8. The network of small pores is connected to the large pores so that the liquidus solution 8 and electric currents may pass both ways between the two sets of pores.

According to yet another preferred embodiment of the present invention, a layer of gelled liquid material may replace both the liquidus solution and the media pad 4. The gelled liquid is made by adding a gelling agent to the liquidus solution 8 and allowing the mixture to set. Upon aging, the gel will become coated in a syneresis liquid that will ensure a capacity for engulfing aerosol and dust particles. The gel layer also contains the conductive layer. Pores in both the gel layer and the conductive layer allow passage of the air to be purified.

According to yet another preferred embodiment of the present invention, the filter may contain one or more layers of metallic mesh screen, such as a metallic mosquito screen netting, which is grounded and applied with a liquidus solution, for example, a mixture of glycerin, water, and sodium laurel sulfate, with sufficient glycerin present to prevent the formation of a dry crust at low relative humidity, where the air to be purified passes through the metallic mesh screen.

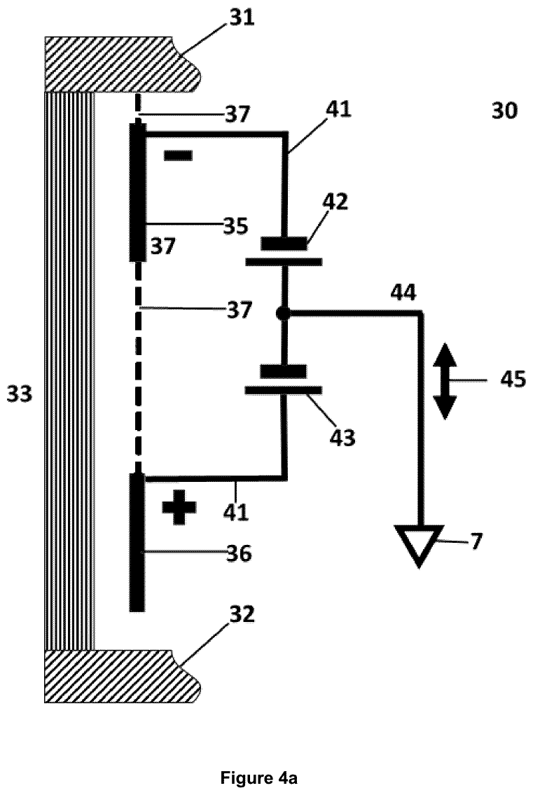

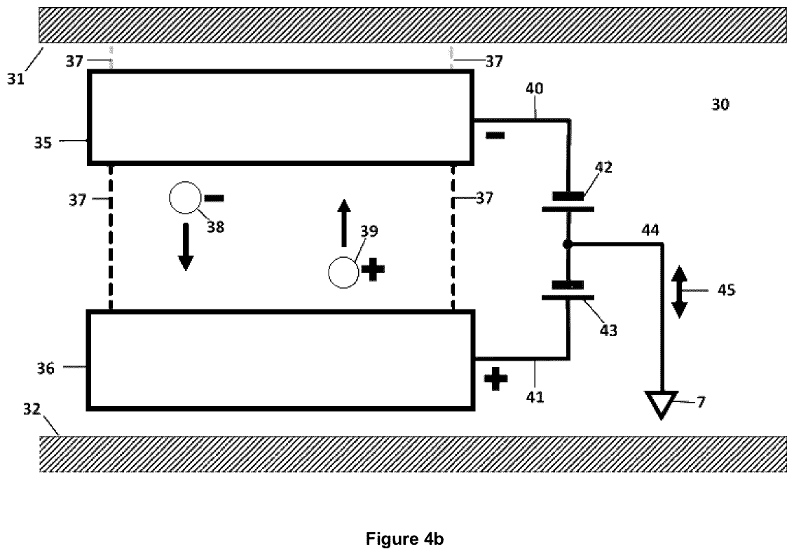

Air to be filtered passes along and parallel to the aforementioned metallic mesh screen. There may be a situation where there is no airflow, and the airborne contaminants are brought to a metallic screen(s) by Coulombic force. Such a device will work better if the screen(s) is placed closer to the dust entry points in the residence or facility and if air sealing has been done to minimize dust entry. FIGS. 4a and 4b show another embodiment of a filter in accordance with the present invention for this particular situation. Referring to FIG. 4a, a ceiling 31, floor 32, and a wall 33 between the ceiling 31 and floor 32. An upper electrically conductive screen filter (metallic mesh filter or conductive plastic mesh) 35 that has been covered with a liquidus solution 8 on one or both sides, and a lower electrically conductive screen filter (metallic mesh filter or conductive plastic mesh) 36 that has been covered with the liquidus solution 8 on one or both sides. The upper screen filter 35 and the lower screen filter 36 are suspended from the ceiling 31 in series by a pair of nonconducting suspension cables 37 with smooth nonporous surfaces. The cables 37 are serving to electrically isolate the two conducting layers from each other and from ground.

Contrary to the embodiment shown in FIG. 4a, the upper electrically conductive screen filter 35 and lower electrically conductive screen filter 36 may be arranged horizontally, instead of vertically, to achieve substantially the same or similar results for filtering air. Similarly, referring to FIG. 4b, the upper conductive screen filter 35 and lower conductive screen filter 36 are suspended from the ceiling 31, being in parallel to each other and to the ceiling 31 and/or floor 32. Further similarly, the upper conductive screen filter 35 and lower conductive screen filter 36 may be arranged vertically, instead of horizontally, to achieve substantially the same or similar results for filtering air.

Now, referring to FIGS. 4a and 4b, electrical wires 40 and 41 connect the upper conductive screen filter 35 and lower conductive screen filter 36, respectively, to two respective, 42 and 43, grounding wires 44 to the ground 7, so as to make the lower conductive screen filter 36 positive relative to ground 7, and the upper conductive screen filter 37 negative. Aerosol or dust particles 38 carrying a negative charge are transported downward by Coulombic forces toward the lower layer 36 where negatively charged dust particles are captured thereby. Aerosol or dust particles carrying a positive charge 39 are transported upward by Coulombic forces toward the upper conductive screen filter 35 where the positively charged dust particles are likewise captured thereby. The arrows shown in FIG. 4b illustrate the directions of transport of the dust particles 38 and 39. A grounding wire 44 is connected to both batteries 42 and 43, which carries currents 45 that discharge to ground 7 any excess of positive or negative charge jointly captured by the upper conductive screen filter 35 and lower conductive screen filter 36. The voltage of each battery is preferably between 48 V and 144 V. A current-limiting resistor of 100 kilohms, not shown, is preferably connected in series with each of electrical wires 40 and 41. The polarities of the upper conductive screen filter 35 and lower conductive screen filter 36 may be reversed if desired. The polarity shown was chosen to reinforce the charge separation that will be induced on the device by the natural “fair-weather” electric field of the atmosphere. Optionally, the batteries may be replaced by straight-through connections and the device operated on induced charge separation only. To maintain performance, the upper conductive screen filter 35 and lower conductive screen filter 36 may be cleaned every three months or so and reapplied to cover the surfaces with the liquidus solution 8, which may be diluted 1:1 w:w with distilled water. Weakly charged dust particles, such as coarse, mechanically resuspended dust particles, may be poorly captured by the filter 30. However, the simplicity of this embodiment lends itself to realization of a high-capacity version in which captured dust is continuously washed away by a flowing liquid layer contacting all of the upper conductive screen filter 35 and lower conductive screen filter 36 on at least one surface.

While the filter 30 shown in FIGS. 4a and 4b comprise the batteries 42 and 43, optionally, the batteries may be taken out, and electrical charge separation is solely induced by the natural fair-weather atmospheric electric field, and the upper conductive screen filter 35 and lower conductive screen filter 36 that are covered with the liquidus solution 8 are further optionally combined onto one. The ground connection is made to the combined upper conductive screen filter 35 and lower conductive screen filter 36, said combined screen filter being preferably at least one meter in vertical extent and preferably extending no lower than 30 cm above the floor. “Vertical” here means parallel to a plumb line.

The ground connection including the grounding wire 44 and building safety ground 7 may be replaced by a connection to a capacitor, supercapacitor, or source of non-ground electrical potential such as a battery.

FIG. 8 shows yet another preferred embodiment in which the air to be purified by the filter of the present invention is passed through a zone of corona discharge, forming an air ionizer 27, immediately prior to passing through the filter 10 of the present invention. A duct 26 confines the flowing air 1 from a first opening (or upstream) 26a to a second opening (or downstream) 26b as the air passes through the air ionizer 27 comprising an array of conductive points 17 disposed evenly across the face of fibrous filter media pad 4 of the filter 10. The conductive points 17 are connected to a source of high voltage 20 of not less than 10 kilovolts by a conductive supporting member 19 that passes outside the duct 26 via an insulator 18 that prevents arcing to the duct 26. The high-voltage power source 20 is completed by a second connection to ground 7. The air ionizer 27 is preferably an unbalanced air ionizer that produces more of one of positive and negative ionized air molecules causing the dust particles to be charged therearound to promote attractions between the charged dust particles and the filter 10.

Regarding the liquidus solution 8 of the present invention, use of sodium laurel sulfate detergent may be replaced with a mixture of a non-ionic detergent and sodium sulfate or sodium bicarbonate, or by sodium bicarbonate alone. Detergent may not be required in the complete absence of incoming oily contaminants and dust particles with at least partly hydrophobic (in the chemical sense) surfaces. The liquidus solution 8 may preferably include a wetting agent, which is often also a detergent, to ensure prompt engulfment of the captured dust particles.

The liquidus solution 8 may further include a non-drying mixture of a non-ionic detergent, distilled water, and calcium chloride (an alternative hygroscopic agent).

Regarding the liquidus solution 8, sodium laurel sulfate may be replaced by a product sold as a wetting agent rather than as a detergent.

According to another embodiment of the present invention, the media pad 4 may be a disc of filter paper or open-cell foam sheeting moistened with a mixture of glycerin, water, sodium laurel sulfate, and an electrolyte, with sufficient glycerin present to prevent the formation of a dry crust at low relative humidity, clamped into a grounded metallic duct flange around the periphery, with the resistance between the center and the flange being no more than one megohm.

According to yet another embodiment of the present invention, a CPAP humidifier chamber may be altered/modified with grounding of the liquid contents and addition of a detergent and electrolyte thereto to provide a polishing air filter. In the normal course of events, the user of a CPAP machine adds distilled water to the chamber periodically to compensate for evaporation. This is an example of a hygroscopic agent-less embodiment. According to yet another embodiment of the present invention, a “crevice device” may be formed, comprising grounded, conductive adhesive tape applied to e.g., the lintels, sills, and jambs of windows and doors and/or on their mating surfaces and coated with the liquid to seal them without friction against the passage of dust. The tape is placed at the narrowest places dust must pass to enter the room, which maximizes the Coulombic force the present invention exerts on it.

The fibers of the filter media pad 4 may be individually coated in a thin layer of the liquidus solution 8, which forms a continuous phase in electrical contact with the metal backup grid 3. The free boundary of the liquidus solution 8 is the site of capture of dust particles. The detergent in the liquidus solution 8 keeps the metal backup grid 3 and free boundary clean by detergent action and thus maintains conduction despite the probable presence of oily contaminants in the air stream that would otherwise coat the metal backup grid 3 and/or free boundary with an insulating layer. According to U.S. Pat. No. 10,994,282 B2, such contaminants might come from cooking and diesel exhaust, as well as, for example, forest fires, or hydrocarbon substances such as isoprenoids that are naturally emitted from forest plants into the air.

Considering oily contaminants (as modeled by olive oil) impinging on the free boundary, the detergent keeps the oil droplet compact after capture, preventing it from spreading out in a thin layer arbitrarily far.

Moreover, the detergent in the liquidus solution 8 is electrically important even if it is non-ionic, facilitating the engulfment of the captured dust particles by the liquid so that static charges are completely neutralized over the entire surface of a captured dust particle(s). In this action, the detergent in the liquidus solution 8 is acting in its role as wetting agent to reduce the surface tension of water. According to published data, the glycerin component does not efficiently reduce the surface tension of its mixtures with water. If the particles to be captured are coated in oily contaminants, the detergent role will also be useful for promoting particle engulfment.

In contrast, known methods of neutralizing non-conductive, air-suspended particles are inefficient; only the point of contact of the particle with the grounded electrode is neutralized.

A further benefit of the detergent component is to provide non-beading, uniform coatings, which will improve the uniformity of the liquid films coating the fibers of the filter media and the conductive layer, and thus the efficiency of the air cleaner device.

The hygroscopic agent in the liquidus solution 8 absorbs water from the ambient air to provide a liquid reaction medium, which is necessary for both the ionic electrical conductivity and the detergency/wetting.

The desirable electrical conductivity of the mixture is due to the electrolyte and/or detergent, if the latter is ionic, which is intended to discharge static electricity on the captured dust particles to the nearest metal backup grid strand and thence to the building safety ground (or vehicle grounding strap, if the filter is used on a vehicle). It is believed that dust is attracted to the filter by its own static charge, which theoretically induces an opposite and attractive “mirror charge” on the filter media pad, but only if the latter is electrically grounded. A static charge on the dust particles can be assumed due to the ubiquitousness of tribocharging in mechanical devices such as heating/ventilating/air-conditioning (HVAC) systems, and in nature, when aerosols are created and dust is transported by wind. Moreover, soot from methane flames was found to be negatively charged (OW Bello, M Kazemimanesh, L Kostiuk, JS Olfert. Combustion and Flame. Volume 269, 2024. https://doi.org/10.1016/j.combustflame.2024. 113691, accessed on Feb. 2, 2025). Furthermore, ASHRAE standard 52.2, appendix B, states: “Electrostatic charging is an unavoidable consequence of most aerosol generation methods.” The mirror-charge effect is already used for a different purpose in industrial powder coating.

The Coulombic forces available from the mirror-charge effect and acting on airborne particles are intensified by a proximity effect; said particles being forced into close proximity to the liquid free surface as the airstream penetrates the pores in the filter media pad. (Coulombic forces between charges increase with the inverse square of the separation.) Therefore, it is believed that the present invention works even with weakly charged particles. Removal of both strongly and weakly charged particles is valuable in all use conditions.

The relationship between mirror charge formation and draining the captured charges to ground can be understood by saying that grounding prevents the former from being self-limiting in the presence of many charged dust particles of the same sign. In a given situation, the incoming dust particles will tend to be all of the same charge sign due to a sorting effect of the natural fair-weather atmospheric electric field. Further, any initial mixture of particle charge signs will produce agglomeration and early settling, leaving a same-sign residue.

### Experimental Results

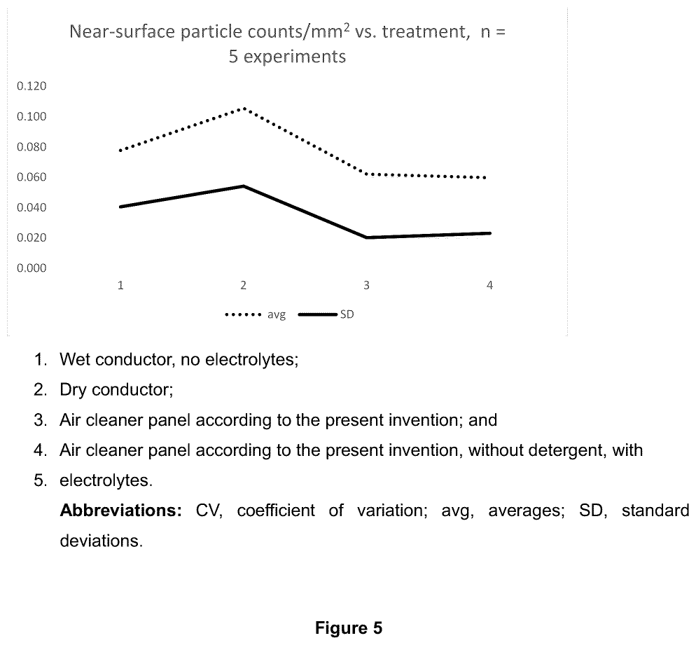

A grounded, vertical 1×4.5′ conductive panel (“conductive layer”) coated with the liquid reduced the concentration of airborne particles in front of it relative to a dry, uncoated but otherwise identical panel. A third otherwise identical panel coated with pure glycerin-water (thus omitting the features “detergent” and “electrolyte”) produced an intermediate reduction. See FIGS. 5, 6 and 7. In FIGS. 5, 6 and 7, 1 represents a filter with wet conductor, no electrolytes; 2: dry conductor; 3: filter according to the present invention; and 4: filter according to the present invention, without detergent, with electrolytes. The filter of the present invention has the lowest coefficient of variation in measured airborne particle concentration. The invention with only the detergent omitted showed equal performance, based on averages, to the complete invention. This can be explained as the ambient dust at the test location being unexpectedly wettable.

Moreover, the preferred embodiment of the present invention in service in a home was observed to remove oil mist at the air inlet register that passed through a simultaneously operating commercial MERV 12 furnace filter.

These results show the effectiveness of the present invention in removing particulate matter from air.

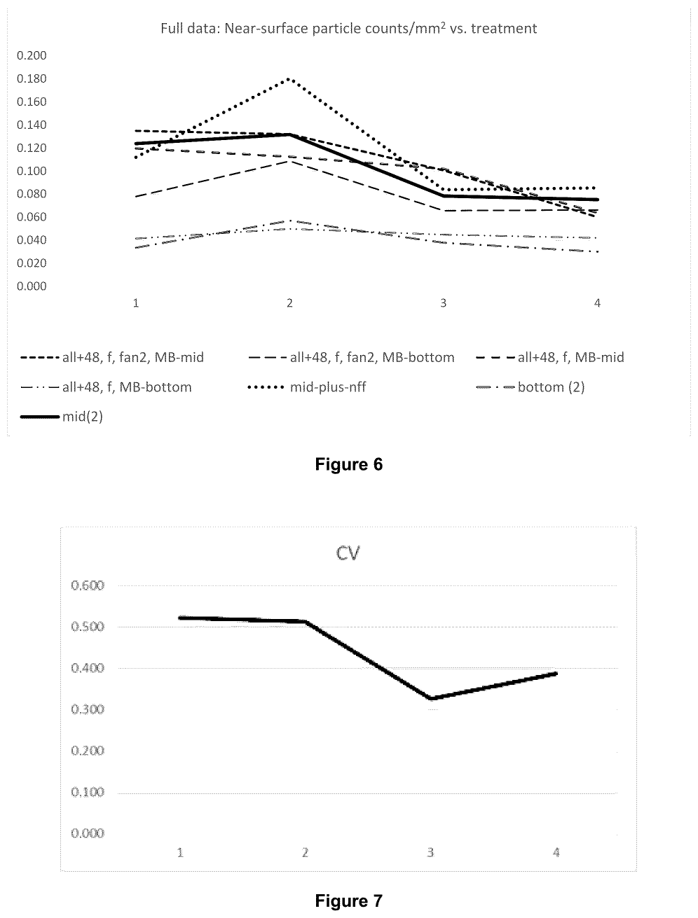

FIG. 6 is the graph showing the measured performance of the filter 30 shown in FIGS. 4a and 4b. A 48V battery was connected in series with the ground connection, which was shared by all four panels, to better reveal the treatment effects. The positive pole of the battery faced the panels. The outliers (line for “all+48, f, fan2, MB-mid” and line for “all+48, f, MB-mid”) are thought to represent days when incoming particles carried a positive charge instead of the normal negative charge.

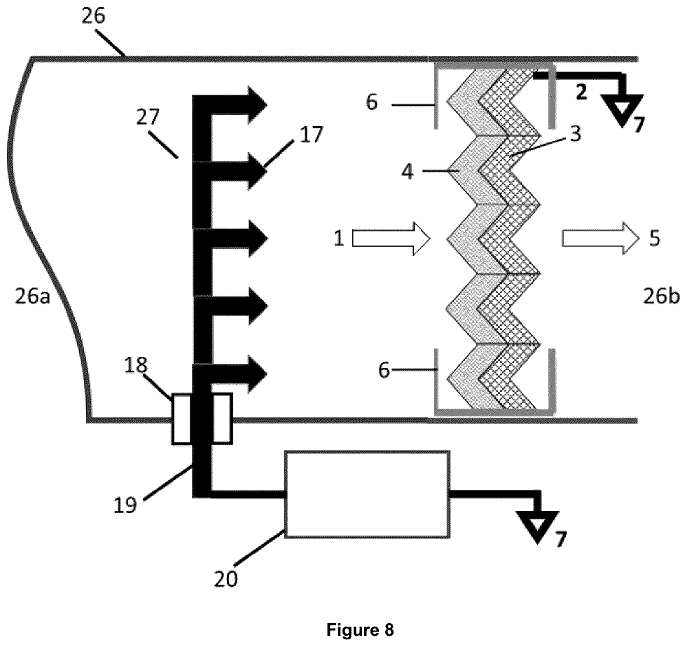

FIG. 7 is the graph showing coefficient of variation on the filters over the measurements.

The present invention may be used as or for the following applications, including, but not limited to:
Filters for the combustion air in furnaces and internal combustion vehicles,
Filtration of clothes-dryer inlet air,
Filter at the inlet of air compressors,
Disposable polishing filters at the inlet and outlet of vacuum cleaners, and
Preventing photovoltaic panels from becoming coated in dust.

The exemplary embodiments described herein are for illustrative purposes only for the present invention, and thus, it would be obvious that the same may be varied in many ways. Such modifications that would be regarded as obvious to one skilled in the pertinent art are intended to be included within the scope of the present invention.

### LIST OF REFERENCE NUMERALS IN DRAWINGS

1 . . . Direction of airflow on the upstream side
1′ . . . Upstream side
2 . . . Grounding wire
3 . . . Metal grid
4 . . . Fibrous filter media pad
4′ . . . Sheet of fibers
5 . . . Direction of airflow on the downstream side
5′ . . . Downstream side
6 . . . Frame
7 . . . Building safety ground
8 . . . Liquidus solution/electrically conductive liquidus solution
9 . . . Glue/adhesive
10 . . . Filter
15 . . . Connector
16 . . . Joints (frame)
17 . . . Array of conductive points
18 . . . insulator
19 . . . conductive supporting member
20 . . . source of high voltage (high voltage power source)
21 . . . Dust particle
21′ . . . Captured particle
22 . . . Coulombic force of attraction
24 . . . Flow of negative charge
25 . . . Pores
26 . . . Duct
26a . . . First opening (upstream)
26b . . . Second opening (downstream)
27 . . . Air ionizer (or unbalanced air ionizer)
30 . . . Filter
31 . . . Ceiling
32 . . . Floor
33 . . . Wall
35 . . . Upper electrically conductive screen filter
36 . . . Lower electrically conductive screen filter
37 . . . Nonconducting suspension cable(s)
38 . . . Negatively charged dust particle
39 . . . Positively charged dust particle
40 . . . Electrical wire
41 . . . Electrical wire
42 . . . Battery
43 . . . Battery
44 . . . Grounding wire
P . . . Peak
V . . . Valley

1. An air filter, comprising:
a media pad being impregnated with a liquidus solution;
a metal grid attached to the media pad covering substantially an entire area of the media pad; and
an electrical connection that electrically maintains the metal grid at ground potential or non-ground voltage source.

2. The air filter according to claim 1, wherein the liquidus solution comprises:
a detergent; and
a hygroscopic agent; and an electrolyte.

3. The air filter according to claim 2, wherein the detergent is an alkyl sodium sulfonate or non-ionic detergent.

4. The air filter according to claim 2, wherein the hygroscopic agent is glycerin.

5. The air filter according to claim 2, wherein the electrolyte comprises an ionizable substance selected from the group consisting of an ionic detergent, sodium sulfate, and sodium bicarbonate.

6. The air filter according to claim 1, wherein the non-ground voltage source is a battery or a charge pump.

7. An air filter, comprising:
a. a pair of conductive mesh filters, a first one of which is adapted to be electrically positively charged; and a second one of which is adapted to be electrically negatively charged; and
b. a liquidus solution covering the positively and negatively charged conductive meshes.

8. The air filter according to claim 7, wherein the pair of conductive mesh filters are metallic mesh filters, conductive plastic mesh filters, or a combination thereof.

9. The air filter according to claim 7, wherein air passes between the pair of conductive mesh filters, passes sequentially among the pair of conductive mesh filters; or passes about one of the pair of conductive mesh filters.

10. The air filter according to claim 7, wherein the liquidus solution comprises:
a detergent;
a hygroscopic agent; and
an electrolyte.

11. The air filter according to claim 7, wherein the detergent is an alkyl sodium sulfonate or non-ionic detergent.

12. The air filter according to claim 7, wherein the hygroscopic agent is glycerin.

13. The air filter according to claim 7, wherein the electrolyte comprises an ionizable substance selected from the group consisting of an ionic detergent, sodium sulfate, and sodium bicarbonate.

14. The air filter according to claim 7, wherein the pair of conductive mesh filters are electrically charged by a battery.

15. The air filter according to claim 7, wherein the pair of conductive mesh filters are arranged horizontally in parallel or side-by-side, or vertically in parallel or side-by-side.

16. A air cleaning device comprising:
a. a duct for receiving air from a first opening and flowing through to a second opening;
b. an air ionizer disposed within the duct, wherein the air from the first opening passes through the air ionizer for ionizing the air; and
c. the air filter as defined in claim 1, wherein the air filter is disposed within the duct for filtering the air ionized by the air ionizer.

17. The air cleaning device according to claim 16, wherein the air ionizer comprises an array of conductive points with a high voltage for ionizing the air, and wherein the high voltage is higher than 10 kilovolts.

18. The air cleaning device according to claim 16, wherein the air ionizer is an unbalanced air ionizer.
